(19) United States
(12) Patent Application Publication
(10) Pub. No.: US 2013/0008922 A1
(43) Pub. Date: Jan. 10, 2013

(54) PASTE DISPENSER

(75) Inventor: HUNG-TSAN SHEN, Tu-Cheng (TW)

(73) Assignee: HON HAI PRECISION INDUSTRY CO., LTD., Tu-Cheng (TW)

(21) Appl. No.: 13/245,874

(22) Filed: Sep. 27, 2011

(30) Foreign Application Priority Data
Jul. 7, 2011 (TW) 100123971

(51) Int. Cl. B05C 17/01; B65D 47/30; B05C 21/00

(52) U.S. Cl. 222/153.13; 222/340; 222/559

(57) ABSTRACT

A paste dispenser includes a bottle, a piston, an elastic element, and a switch. The bottle includes a main body and a neck connected to the main body. The main body includes a bottom wall facing the neck. The piston is received in the main body, and hermetically divides the bottle into a first and a second receiving spaces. The first receiving space receives paste. The first elastic element is compressed between the bottom wall and the piston. An uncompressed length of the first elastic element is equal to or greater than a length of the main body. The switch is mounted on the neck and used for controlling the flow rate of the paste. When the switch is turned on, the first elastic element pushes the piston to squeeze the paste out of the neck. When the switch is turned off, the first receiving space is sealed up.

### BACKGROUND

1. Technical Field

The present disclosure relates to paste dispensers and, particularly, to a paste dispenser from which paste can automatically flow.

2. Description of Related Art

A container, such as a toothpaste tube, or a bottle of cream, needs to be crushed by users to push the paste out. If there is very little paste remaining in the container, it is very inconvenient to push the paste out.

Therefore, it is desirable to provide a paste dispenser that can overcome the above-mentioned limitations.

### BRIEF DESCRIPTION OF THE DRAWINGS

Many aspects of the embodiments are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross-sectional view of a paste dispenser, according to a first exemplary embodiment.

FIG. 2 is a cross-sectional view of a paste dispenser, according to a second exemplary embodiment.

### DETAILED DESCRIPTION

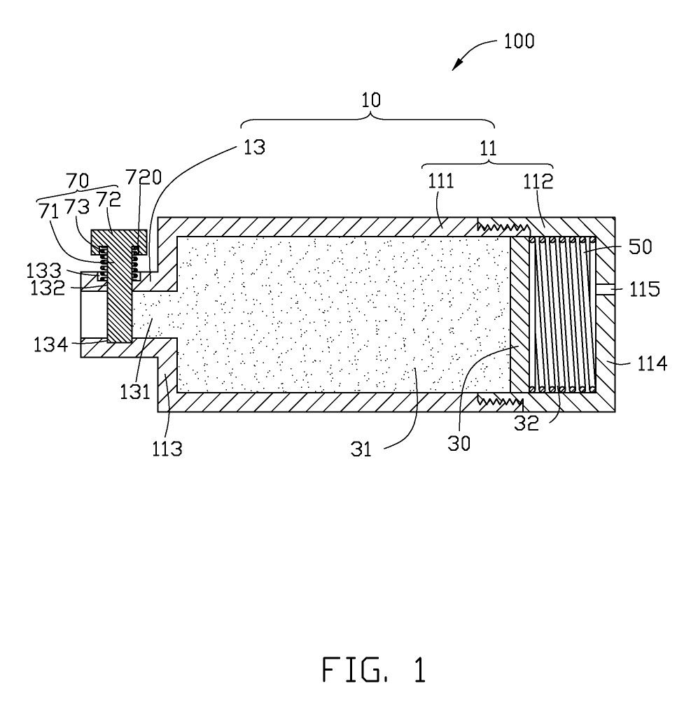

Referring to FIG. 1, a paste dispenser 100, according to a first embodiment, includes a bottle 10, a piston 30, a first elastic element 50, and a switch 70.

The bottle 10 includes a cylindrical main body 11 and a neck 13 connected to the main body 11. The neck 13 defines a first through hole 131. The first through hole 131 provides an outlet from the main body 11. A sidewall of the neck 13 defines a second through hole 132 communicating with the first through hole 131. The outer surface of the sidewall of the neck 13 defines a first fixing groove 133 coaxial with the second through hole 132. The inner surface of the sidewall of the neck 13 defines a receiving groove 134 also aligned with the second through hole 132. In this embodiment, the bottle 10 is rigid, and is made of glass, plastic, or metal. The main body 10 includes a first portion 111 and a second adjoining portion 112. The first portion 111 and the second portion 112 are screwed together. The second portion 112 includes a bottom wall 114. The bottom wall 114 defines an air inlet 115. The first portion 111 and the neck 13 are integratedly formed with each other.

The piston 30 is received in the main body 11, and forms a hermetic seal with the sidewall of the main body 11, and divides the bottle 10 into a first receiving space 31 and a second receiving space 32. The first receiving space 31 is adjacent to the neck 13 and communicated with the first through hole 131, and is used for receiving paste or other dispensable substance. The second receiving space 32 is at the bottom, and communicates with the outside through the air inlet 115.

The first elastic element 50 is received in the second receiving space 32. The pushing force of the first elastic element 50 is parallel with the longitudinal axis of the bottle 10. The first elastic element 50 is compressed between the bottom wall 114 and the piston 30, and thus the first elastic element 50 can push the piston 30 towards the neck 13. The uncompressed length of the first elastic element 50 is equal to or greater than the length of the main body 11. In this embodiment, the first elastic element 50 is a spring. In another embodiment, the first elastic element 50 can be resilient metal, or an elastic rubber pole.

The switch 70 is mounted on the neck 13, and is used for controlling the flow rate of the paste. When the switch 70 is turned off, the first receiving space 31 is sealed up. In this embodiment, the switch 70 is a valve, and includes a stopper 71, a handle 72, and a second elastic element 73. The handle 72 is fixed on the outer end of the stopper 71. The stopper 71 moveably extends through the first through hole 131 and is partially received in the receiving groove 134. When the inner end of the stopper 71 is received in the receiving groove 134, the first through hole 131 is sealed up by the stopper 71.

The handle 72 defines a second fixing groove 720 spatially corresponding to the first fixing groove 133. Two ends of the second elastic element 73 are received in the first fixing groove 133 and the second fixing groove 720. When a user pulls out the handle 72, the first through hole 131 is opened, the second elastic element 73 is compressed, and the first elastic element 50 is allowed to push the piston 30 towards the first through hole 131 to push the paste out, the paste flow rate can be controlled by how far the stopper 71 is pulled out. When the handle 72 is released, the second elastic element 73 pulls the stopper 71 back to the original position and the first through hole 131 is again sealed. The second elastic elements 73 prevents the stopper 71 from coming out of the second through hole 132, and thus paste can not leak from the paste dispenser 100 through the hole 132. In this embodiment, the second elastic element 73 is a spring. The spring 73 is sleeved over the stopper 71. In other embodiment, the second elastic element 73 can be a rubber band. The configuration of the switch 70 is similar to that of a tap.

Because the uncompressed length of the first elastic element 50 is equal to or greater than the length of the bottle 10, the first elastic element 50 can push against the piston 30 until the piston 30 abuts a top wall 113 of the bottle 10, and thus all of the paste in the bottle 10 can be expended.

In other embodiments, the neck 13 may be not integrated with the first portion 111.

In other embodiments, if the diameter of the first through hole 131 is small or the compressive force of the first elastic element 50 is small, and thus the flow rate of the paste is slow, a bottle cap can be used to seal up the first receiving space 31. In that case, the second elastic element 73 can be omitted, the stopper 71 can be screwed in or out of the second through hole 132 to prevent the switch 70 from dropping off and to leave the maximum flow rate of the paste at a certain level.

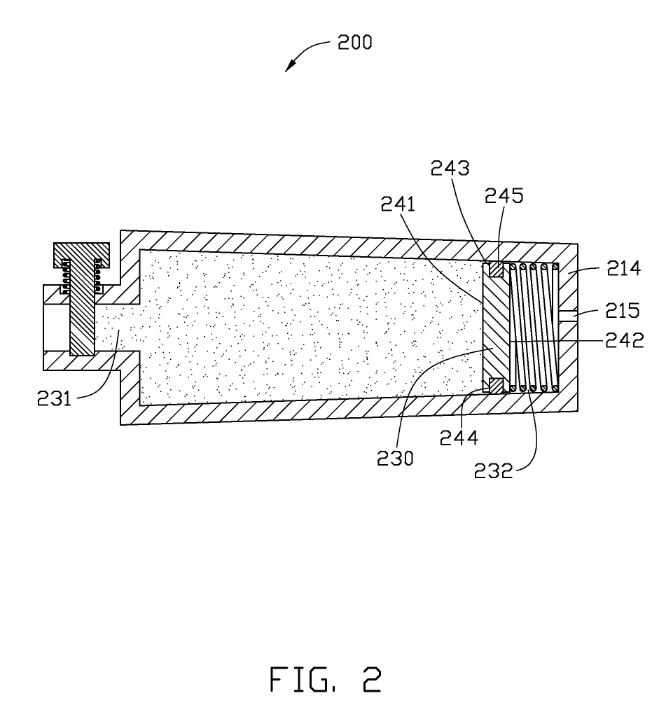

Referring to FIG. 2, the paste dispenser 200, according to a second embodiment is similar to the first embodiment of the paste dispenser 100 of FIG. 1, except that the paste dispenser 200 includes a main body 21 and a piston 230 different from those of the paste dispenser 100. The main body 21 is made of plastic material. In this embodiment, the main body 21 includes a bottom wall 214. The bottom wall 214 defines an air inlet 215. The main body 21 tapers from the neck 13 towards the bottom wall 214.

The piston 230 is received in the main body 21 and includes a first surface 241, an opposite second surface 242, and a sidewall 243. The first surface 241 faces the neck 13. The second surface 242 faces the bottom wall 214. The sidewall 243 is connected to the first surface 241 and the second surface 242, and a continuous slot 244 is defined around the circumference thereof. A resilient plastic seal 245 fills up the continuous slot 244 and contacts the inner surface of the main body 21. The main body 21 defines a first receiving space 231 and a second receiving space 232 separated from the first receiving space 231 by the piston 230. The first elastic element 50 is received in the second receiving space 232 and compressed between the bottom wall 214 and the second surface 242. When the piston 230 moves towards the neck 13, the seal 245 expands from the continuous slot 244 to fill up the greater diameter of the inner sidewall of the main body 21, and thus the paste is again hermetically sealed in the first receiving space 231.

The paste dispenser 200 is made by the injection molding method. The piston 230 and the first elastic element 50 are received in a mold (not shown) before the injection molding of the paste dispenser 200.

In other embodiments, the shape of the piston 130 may be the same as the shape of the piston 230.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A paste dispenser comprising:
a hollow bottle which comprises a main body and a neck connected to the main body, the main body having a bottom wall facing the neck;
a piston received in the main body and providing a hermetic seal with a sidewall of the main body, and thus to divide the bottle into a first receiving space and a second receiving space, wherein the first receiving space is configured for receiving paste;
a first elastic element received in the second receiving space, the first elastic element being compressed between the bottom wall and the piston, and thus the first elastic element capable of pushing the piston towards the neck, wherein an uncompressed length of the first elastic element is equal to or greater than a length of the main body; and
a switch mounted on the neck, and configured for controlling the flow rate of the paste, wherein when the switch is turned on, the paste is pushed by the piston to flow outside from the neck, when the switch is turned off, the paste is sealed in the first receiving space.

2. The paste dispenser of claim 1, wherein the bottom wall defines an air inlet, the second receiving space is communicating with the outside of the paste dispenser through the air inlet.

3. The paste dispenser of claim 1, wherein the piston comprises a first surface, a second surface opposite to the first surface, and a sidewall connecting to the first surface and the second surface, the sidewall defines a continuous slot along the circumference thereof, the piston comprises a resilient plastic seal filling up the slot and contacting the sidewall of the main body, the first elastic element is compressed between the bottom wall and the second surface.

4. The paste dispenser of claim 3, wherein the main body tapers from the neck towards the bottom wall, the resilient plastic seal is capable of expanding from the slot to contact the sidewall of the main body when the piston moves towards the neck, and thus the paste is hermetically sealed in the first receiving space.

5. The paste dispenser of claim 1, wherein the switch is a valve, the valve comprises a stopper, the neck defines a first through hole for providing an outlet from the main body, a sidewall of the neck defines a second through hole communicating with the first through hole, the stopper movably extends through the second through hole, and is thus capable of opening or plugging the first through hole.

6. The paste dispenser of claim 5, wherein an inner surface of the sidewall of the neck further defines a receiving groove aligned with the second through hole, when one end of the stopper is received in the receiving groove, the first through hole is sealed up.

7. The paste dispenser of claim 5, wherein the switch further comprises a handle extending from the stopper and positioned outside the bottle.

8. The paste dispenser of claim 7, wherein the switch further comprises a second elastic element, the second elastic element is positioned between the neck and the handle and configured for providing an elastic force to push the handle and stopper away from the neck.

9. The paste dispenser of claim 8, wherein an outer surface of the neck defines a first fixing groove coaxial with the second through hole, a surface of the handle facing the neck defines a second fixing groove spatially corresponding to the first fixing groove, two opposite ends of the second elastic element are respectively received and positioned in the first fixing groove and the second fixing groove.

10. The paste dispenser of claim 1, wherein the main body comprises a first portion and a second portion coaxial with the first portion and connected to the first portion, the first portion is connected to the neck, the second portion comprises the bottom wall.
